(19) United States
(12) Patent Application Publication
(10) Pub. No.: US 2002/0076040 A1
(43) Pub. Date: Jun. 20, 2002

(54) Structure of headphone

(75) Inventor: Charles Pao-Hui Sung, Chung-Ho City (TW)

Correspondence Address: DAVID E. DOUGHERTY, DENNISON, SCHULTZ & DOUGHERTY, 612 CRYSTAL SQUARE 4, 1745 JEFFERSON DAVIS HIGHWAY, ARLINGTON, VA, 22202, US

(73) Assignee: Toong In Electronic Corp.

(21) Appl. No.: 09/739,864

(22) Filed: Dec. 20, 2000

(51) Int. Cl. H04M 1/00; H04M 9/00

(52) U.S. Cl. 379/430; 379/431

(57) ABSTRACT

An improved structure of headphone comprising: an arched straddle type strip, one end of the straddle type strip is provided with an earphone, an enlarged piece is provided on the other end of the arched straddle type strip, a flexible twig with a microphone on its own end is connected to the lower end of the earphone, the structure is characterized by that: the enlarged piece is provided with a soft cover having on the front and the rear ends thereof elastic hollow protrusions for contacting a lateral side of a head; thereby, the headphone can take advantage of the soft and comfortable elastic hollow protrusions for wearing and fixing after adjustment on and any head with different size, thus a practical structure of headphone is obtained.

### BACKGROUND OF THE INVENTION

The present invention is related to improved headphone, and especially to an improved structure of headphone with larger scope of application and being comfortable for well fixing and wearing on any head of different size.

Since inventing of earphones, they have been the most preliminary auxiliary instruments for music enjoyment; they have gone through the prevailing periods of phonographs, radios, records, walkmans etc., thereby, they are variant in structural function or change of appearance. In the recent years, application on multimedia for computers and popularization of mobile phones make people continuously weed through the old earphones and bring forth the new ones; wherein, not only practicable earphones which are convenient and getting more and more humanistic in use are provided to satisfy the psychological renewing of people, but even more importantly, products of earphones are made to be leading in and to keep their competitive markets, and these are the subjects toward them the manufacturers vie with each other in doing study and development.

A conventional headphone is comprised mainly of an arched straddle type strip, one end of the straddle type strip is provided with an earphone, a flexible twig with a microphone on its own end is connected to the lower end of the earphone. The other end of the arched straddle type strip is provided with an enlarged piece which can strengthen holding capability when the conventional headphone is worn on. Thereby, the headphone can be used to listen and answer with one ear, and the other ear can be used to notice messages induced in site. However, the enlarged piece of such a conventional headphone is mostly a simple sheet with a fixed shape, the wearer of it is subjected to feeling pain and discomfort after wearing it a long time period, and the enlarged piece can not be adjusted in pursuance of the size of the head of a man. For example, a computer may be required for a modern family for interplay between parent and children; design of such a headphone is not good to be commonly used: e.g., it only suit adults, but cannot be fixed well for children.

Although quite a few designs have added foam pad on the enlarged piece to make comfort of wearing, it is not negligible that the headphone cannot suit various sizes of heads and thus cannot be fixed well.

### SUMMARY OF THE INVENTION

Thereby, the inventor provided the present invention after profound study and improvement based on many experiments.

The object of the present invention is to provide an improved structure of headphone with large scope of application and being comfortable for well fixing and wearing on any head of different size.

To get the above stated objects, the improved structure of headphone of the present invention is comprised mainly of an arched straddle type strip, one end of the straddle type strip is provided with an earphone, an enlarged piece is provided on the other end of the arched straddle type strip, a flexible twig with a microphone on its own end is connected to the lower end of the earphone. The improved structure of headphone is characterized by that: the enlarged piece is provided with a soft cover having on the front and the rear ends thereof elastic hollow protrusions for contacting a lateral side of a head. Thereby, the headphone can take advantage of the soft and comfortable elastic hollow protrusions for wearing and fixing after adjustment on any head with different size, thus a practical structure of headphone is obtained.

The present invention will be apparent in its combination and operational features after reading the detailed description of the preferred embodiment thereof in reference to the accompanying drawings.

### BRIEF DESCRIPTION OF THE DRAWINGS

FIG. 1 is a perspective view showing the appearance of the present invention;

FIG. 2 is an analytic perspective view of the present invention;

FIG. 3 is a schematic view showing combination of an enlarged piece and its cover of the present invention;

FIG. 4 is a schematic view showing application of the present invention;

FIG. 5 is an enlarged schematic view of a part of FIG. 4;

FIG. 6 is another schematic view showing application of the present invention;

FIG. 7 is an enlarged schematic view of a part of FIG. 6.

### DETAILED DESCRIPTION OF THE PREFERRED EMBODIMENT

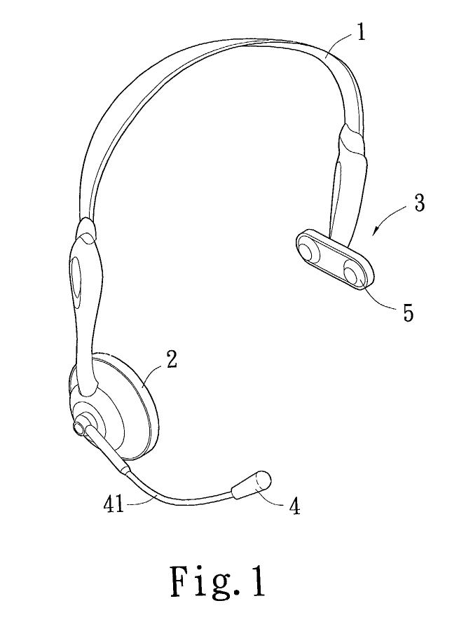

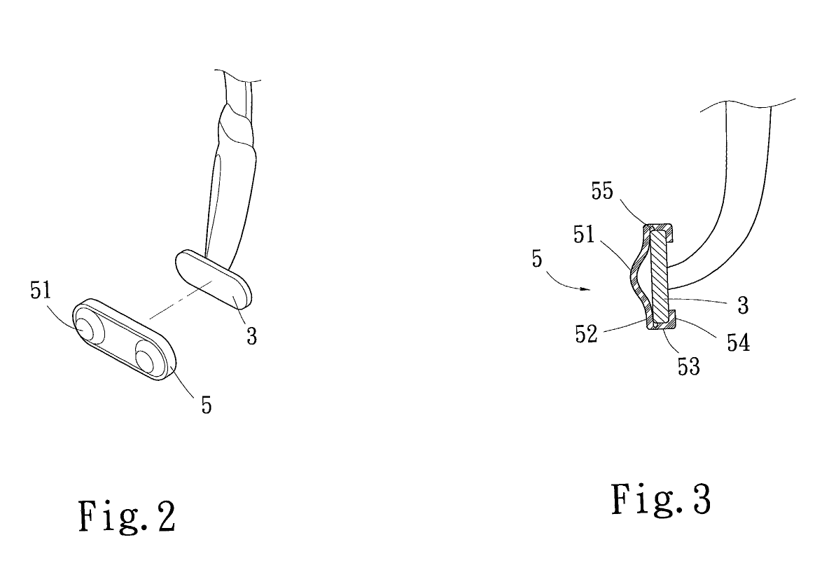

Referring to FIG. 1-3, the improved structure of headphone of the present invention is comprised mainly of an arched straddle type strip 1, one end of the straddle type strip 1 is provided with an earphone 2, an enlarged piece 3 is provided on the other end of the arched straddle type strip 1, a flexible twig 41 with a microphone 4 on its own end is connected to the lower end of the earphone 2. The improved structure of headphone is characterized by that: the enlarged piece 3 is provided with a soft cover 5 having on the front and the rear ends thereof elastic hollow protrusions 51 for contacting a lateral side of a head.

When in practice, the soft cover 5 of the enlarged piece 3 with the protrusions 51 is made of soft gelatin material, such as rubber or silicone, and most preferably the elastic hollow protrusions 51 are spaced from each other respectively on the front and the rear ends of the soft cover 5.

The cover 5 is provided particularly with an enclosure surface 52, a peripheral covering side 53 and a binding opening 54. The enclosure surface 52 is provided on the front and the rear ends thereof with the elastic hollow protrusions 51; while the peripheral covering side 53 is provided at the corner of the internal wall thereof with a circle of hollow space 55 for receiving the enlarged piece 3.

As shown in FIG. 1 and 3, when in assembling, the enlarged piece 3 can be placed into the binding opening 54 of the cover 5 to be located and fixed in the hollow space 55, the enlarged piece 3 thereby is effectively engaged firm by the cover 5 and is not subjected to dropping. Therefore, in use of the present invention, the soft cover 5 can increase softness and comfort in wearing the headphone. And by providing the elastic hollow protrusions 51 on the front and the rear ends of the soft cover 5, the headphone can be well fixed and worn on any head of different size.

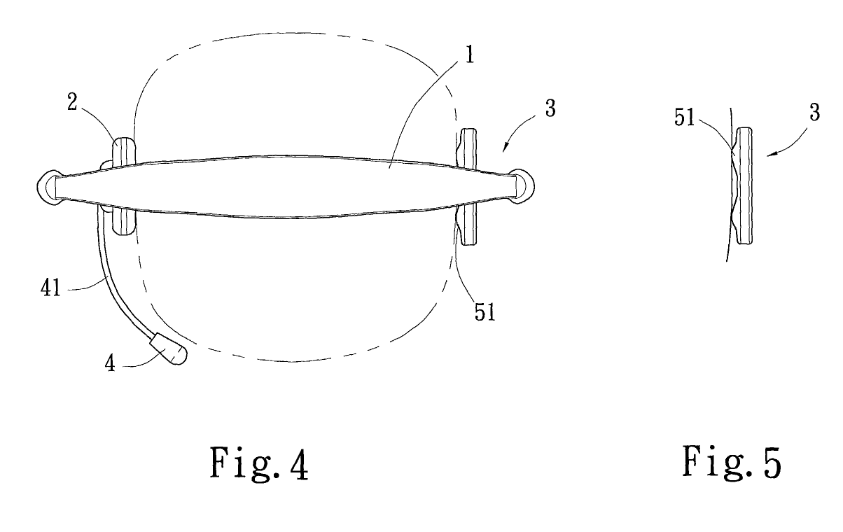

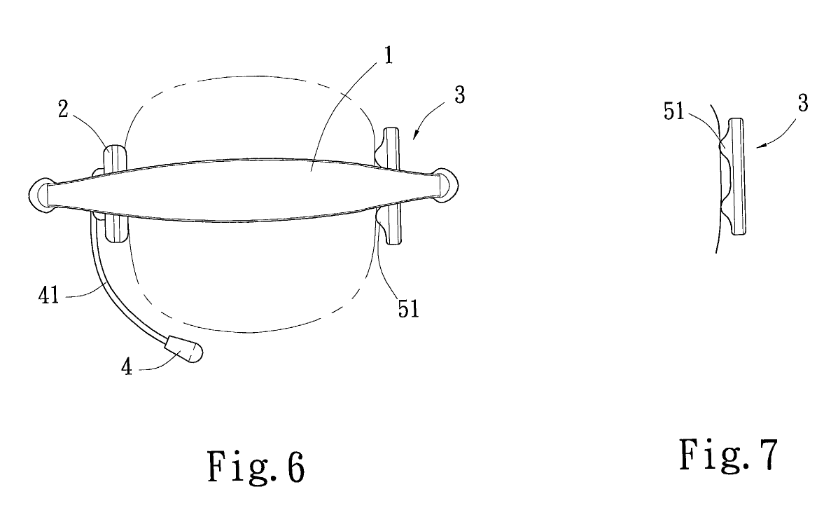

For example, FIG. 4 and 5 show the case when the headphone is worn on a head with a larger size (such as of an adult), the elastic hollow protrusions 51 can be appropriately pressed as an adjustment to make it be comfortably worn; while in the case as shown in FIG. 6 and 7 when the headphone is worn on a head with a smaller size (such as of a child), the elastic hollow protrusions 51 can be kept unchanged from the original protruding state, or only is slightly pressed in pursuance of the size of the child's head. Therefore, the headphone can have a larger scope of application and can be comfortable for well fixing and wearing on any head of different size.

In conclusion, the novel structure of the present invention can make wearing of the headphone softer and more comfortable, and can have a larger scope of application to be comfortable for well fixing and wearing on any head of different size. The present invention is evidently advanced in comparison with conventional structures, it has never existed in the markets or appeared on publications, and it is industrial valuable.

Having thus described my invention, what I claim as new and desire to be secured by Letters Patent of the United States are:

1. An improved structure of headphone comprising:
an arched straddle type strip, one end of said straddle type strip is provided with an earphone, an enlarged piece is provided on the other end of said arched straddle type strip, a flexible twig with a microphone on its own end is connected to the lower end of said earphone, said structure is characterized by that:
said enlarged piece is provided with a soft cover having on the front and the rear ends thereof elastic hollow protrusions for contacting a lateral side of a head; thereby, said structure makes a wearer of said headphone fell softer and more comfortable, and has a larger scope of application for any head of different size.

2. An improved structure of headphone as defined in claim 1, wherein,
said soft cover of said enlarged piece with protrusions is made of soft gelatin material, and has said elastic hollow protrusions spaced from each other on said front and rear ends thereof.

3. An improved structure of headphone as defined in claim 2, wherein,
said cover is provided with an enclosure surface, a peripheral covering side and a binding opening, said enclosure surface is provided on the front and the rear ends thereof with said elastic hollow protrusions; while said peripheral covering side is provided at the corner of the internal wall thereof with a circle of hollow space for receiving said enlarged piece.
